(19) United States
(12) Patent Application Publication
(10) Pub. No.: US 2019/0330432 A1
(43) Pub. Date: Oct. 31, 2019

(54) Two-component hybrid matrix system made of polyurethanes and polymethacrylates for the production of short-fibre-reinforced semifinished products

(71) Applicant: Evonik Degussa GmbH, Essen (DE)

(72) Inventors: Zuhal Tuncay, Herne (DE); Holger Loesch, Herne (DE); Christina Cron, Velbert (DE); Elke Gollan, Herne (DE); Lisa-Maria Elmer, Munster (DE)

(73) Assignee: Evonik Degussa GmbH, Essen (DE)

(21) Appl. No.: 16/387,058

(22) Filed: Apr. 17, 2019

(30) Foreign Application Priority Data
Apr. 27, 2018 (EP) 18169724.4

(51) Int. Cl. C08J 5/24; C08L 75/04

(52) U.S. Cl. CPC C08J 5/24; C08L 75/04; B29C 67/246; C08J 2433/08; C08J 2375/04

(57) ABSTRACT

A novel 2-component system and a process using the system produce semifinished component products that are stable in storage, in particular sheet moulding compounds (SMC) and mouldings produced therefrom (composite components). The process has five stages, including three different reactive steps which lead to successively increasing hardness levels. The 2-component system is applied to fibre material, e.g. carbon fibres, glass fibres or polymer fibres, or the 2-component system is brought into contact with short fibres, whereupon a first reaction takes place. This is followed by thermal polymerization initiated by redox initiation or with the aid of radiation or of plasma applications. Polymerization produces thermoplastics or, respectively, thermoplastic prepregs, which can then subsequently be moulded. Polyols present can finally be crosslinked, via elevated temperature, with uretdiones already present in the system. It is thus possible to produce dimensionally stable thermosets or crosslinked composite components.

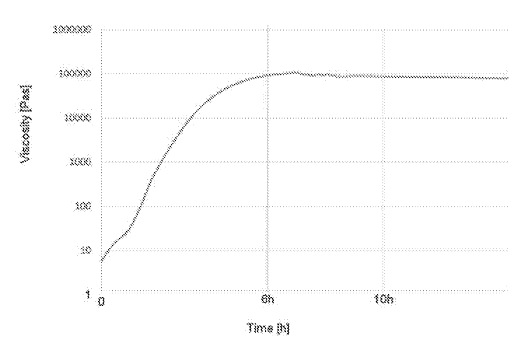

### CROSS-REFERENCE TO RELATED APPLICATIONS

The present application claims priority to European patent application EP 18169724.4 filed Apr. 27, 2018, the content of which is incorporated by reference in its entirety.

### BACKGROUND OF THE INVENTION

### Field of the Invention

The invention relates to a novel 2-component system and to a process with use of this 2-component system for the production of semifinished component products that are stable in storage, in particular sheet moulding compounds (SMC) and mouldings produced therefrom (composite components). The process here has five stages, which include three different reactive steps which lead to successively increasing hardness levels. Known processes are used here to apply the 2-component system to fibre material, e.g. carbon fibres, glass fibres or polymer fibres, or to bring the 2-component system into contact with short fibres, whereupon a first reaction takes place. This is followed by thermal polymerization initiated by redox initiation or with the aid of radiation or of plasma applications.

### Discussion of the Background

Polymerization produces thermoplastics or, respectively, thermoplastic prepregs, which can then subsequently be moulded. Polyols present can finally be crosslinked, via elevated temperature, with uretdiones already present in the system. It is thus possible to produce dimensionally stable thermosets or, respectively, crosslinked composite components.

Fibre-reinforced materials in the form of pre-impregnated semifinished products, i.e. prepregs, are already used in many industries because they are easy to handle and provide increased efficiency in processing when comparison is made with the alternative liquid-impregnation process that is also termed wet lay-up. Industrial users of such systems demand not only faster cycles and increased stability in storage—at temperatures including room temperature—but also the possibility, when the prepregs are cut to size, of avoiding contamination of the cutting implements by the frequently sticky matrix material during automated cutting-to-size and lay-up of the individual prepreg layers.

Another increasingly important type of composite materials is provided with Sheet Moulding Compounds (SMC). These differ from the continuous-fibre-reinforced prepregs discussed above in essence in that they comprise short fibres. SMC therefore incur lower costs for the fibres, and therefore incur lower total production costs. Although they exhibit less mechanical stability than prepregs with continuous fibres, this is compensated by greater design freedom when SMC are used, in particular in relation to variation of material thicknesses within an individual workpiece. SMC are produced by bringing a resin in liquid form into contact with the short fibres and then ripening to give a high-viscosity sticky composition. If the ripening is to take place at room temperature, SMC production requires use of a 2-component system with defined pot life. In the technology generally used, the primary viscosity increase is generally achieved by way of complexing with magnesium oxide. However, these added inorganic substances not only influence the optical properties of the product but also alter the mechanical properties of the final product.

Various processes can be used for the production of composite components. These can have either one or two stages. The two-stage processes generally operate by way of prepregs, tapes or SMC as intermediate stage. The first procedure uses a matrix material to impregnate a fibre material. The resultant semifinished product can be placed into intermediate storage and processed at a later juncture.

Crosslinking matrix systems used are typically unsaturated polyesters, vinyl esters and epoxy systems. They moreover include polyurethane resins which because of their toughness, damage tolerance and strength are in particular used for production of composite profiles by way of pultrusion processes. A frequently mentioned disadvantage of these PU-based systems is the toxicity of the isocyanates used. However, the toxicity of epoxy systems and the hardeners used therein must also be regarded as critical. This is in particular true in relation to known sensitizations and allergies.

Prepregs and composites produced therefrom, based on epoxy systems are described by way of example in WO 98/50211, EP 0 309 221, EP 0 297 674, WO 89/04335 and U.S. Pat. No. 4,377,657. However, the semifinished products produced therefrom are not stable in storage and therefore require storage at low temperatures. WO 2006/043019 describes a process for the production of prepregs based on epoxy-resin-polyurethane powders. There are also known prepregs based on pulverulent thermoplastics as matrix. However, thermoplastic materials are per se less stable in the final composite product.

There are likewise known prepregs with a matrix based on 2-component polyurethanes (2-component PUR). The 2-component PUR category in this sense comprises the traditional reactive polyurethane resin systems. These are in principle systems made of two separate components. While the significant constituent of one component is always a polyisocyanate, examples being polymeric methylenediphenyl diisocyanates (MDI), the significant constituent in the second component is polyols or else in more recent developments amino- or amine-polyol mixtures. The two parts are mixed together only shortly before processing. Chemical hardening then takes place via polyaddition, with formation of a network made of polyurethane or of polyurea. After the mixing of the two constituents, two-component systems have a limited processing time (operating time, pot life), since the onset of reaction leads to gradual viscosity increase and finally to gelling of the system. Effective processability time here is determined by a large number of variables: reactivity of the reactants, catalysis, concentration, solubility, moisture content, NCO/OH ratio and ambient temperature being the most important [in this connection see: Coating Resins, Stoye/Freitag, Hauser-Vertag 1996, pages 210/212]. The disadvantage of prepregs based on such 2-component PUR systems is that only a short period of time is available for the processing of the prepreg to give a composite. The stability of such prepregs is therefore insufficient for storage over a number of hours, and certainly insufficient for storage over a number of days, and they are therefore unsuitable for production of semifinished products.

PU-based semifinished products can be produced by blocking the reactive free isocyanate groups, as described by way of example in EP 2 411 454 and EP 2 411 439. Here, by way of example, prepolymers are synthesized in advance from internally blocked isocyanates, known as uretdione dimers, and diol, and are subsequently mixed in the melt with a polyol. The mixture is stable in storage, and can be processed as single-component system. The systems may also comprise poly(meth)acrylates as co-binder or polyol component.

For easier impregnation, the powder can, as described in EP 2 619 242, be dissolved in a solvent, whereupon viscosity decreases dramatically and impregnation can be achieved at RT. However, the intention here is that the solvent be removed completely from the semifinished product alter impregnation; this is attended by additional cost.

In EP 2 576 648 such compositions are introduced into the fibre material by a direct melt impregnation process. These systems have the disadvantage of high melt viscosity or, respectively, use of solvents which at some stage require removal or else they can have associated toxicological disadvantages.

EP 2 661 459 describes a single-component matrix system in which the prepolymer is dissolved not in solvent but instead in (meth)acrylate monomers and OH-functional (meth)acrylate monomers. The monomers provide a viscosity reduction. However, they do not require removal after impregnation, but instead react via free-radical polymerization to give the polymer chains which are part of the final product. The solvent viscosity of such systems depends inter alia on the nature and concentration of the (meth)acrylate monomer used. If a monomer such as methyl methacrylate (MMA) is used, low viscosity can be ensured by using a low concentration of MMA. However, the monomer MMA has a high vapour pressure and vaporizes very rapidly at RT; it is therefore not possible to use an open process for production of the semifinished product.

EP 2 970 606 discloses the combination of a reactive (meth)acrylate resin and a blocked isocyanate component. The said composition is used here to impregnate the fibre material, and then the reactive resin is hardened by means of radiation. This prepreg can then be moulded before the isocyanate component is hardened. However, a disadvantage in this system has been found to be that the necessary melt viscosity for further processing of the prepregs at the required crosslinking temperatures is generally very high. It is therefore necessary to set very high press pressures; otherwise the quality and mechanical properties of the composite are inadequate.

Alongside these improvements for optimizing prepreg technology, there is moreover a major requirement for a significant improvement in SMC technology. This is the reason for the major requirement for a polyurethane-based system which at room temperature can assume a condition with relatively high viscosity, known as the B-stage. By way of example, the system according to EP 2 970 606 optimized for prepregs requires significant introduction of energy in the form of UV light or of a temperature increase in order to initiate the polymerization and thus the viscosity increase.

### SUMMARY OF THE INVENTION

In the light of the related art, the present invention addresses the object of providing novel SMC-production technology which can lead to a simpler process for the production of SMC systems that provide problem-free handling and that are particularly easy to produce.

In particular, it was an object of the present invention to provide an improved SMC-production process that, in contrast with the related art, requires no addition of inorganic salts, thus resulting in SMC with better mechanical and optical quality.

In combination therewith, a further object was to realize a process where pot life prior to reaching the B-stage can be adjusted in a defined manner during SMC production. This means that the time within which a condition of high viscosity is reached at room temperature, while at the same time the surface remains sticky, can easily be adjusted by modifying the raw-material composition of the matrix.

Another object addressed was provision of mouldings with particularly high quality and very good mechanical properties as downstream product of the SMC. These are intended to be amenable to particularly simple production and processing, without any exceptional capital expenditure for the necessary tooling. A particular intention here is to minimize the brittleness of the final product and to increase ductility.

Other objects not explicitly mentioned can be derived from the description below, from the embodiments or from the examples, and also from combinations of these.

The objects are achieved by means of a novel 2-component system comprising a component A and a component B for the production of the composites. A particular feature of this 2-component system is that the first component A comprises a uretdione dimer having 2 free isocyanate groups, and comprises at least one (meth)acrylate monomer. At the same time, the second component B comprises at least one diol, at least one polyol with, on average, from 2.1 to 4 OH groups, and one activator for methacrylate polymerization.

It is preferable here that the ratio by mass of component A and component B is from 4:1 to 1:1.

It is particularly preferable that the component A of the 2-component system consists of from 10% to 50% by weight of alkyl (meth)acrylates, from 40% to 89.9% by weight of uretdione dimer, from 0% by weight to 40% by weight of polyester and/or poly(meth)acrylates and from 0.1% to 20% by weight of additives, stabilizers, catalysts, pigments and/or fillers.

Component B of the 2-component system preferably consists of from 25% to 99.5% by weight of diol and polyol, from 0.5% to 5% by weight of an initiator as activator, and optionally up to 20% by weight of additives, stabilizers, catalysts, pigments and/or fillers. The molar ratio of diol to polyol here is from 6:2 to 3:2.5. The number-average molar mass Mₙ of the diol is moreover from 50 to 300 g/mol, and the number-average molar mass Mₙ of the polyol is moreover from 90 to 800 g/mol, and the hydroxy number of the polyol is from 150 to 900 mg KOH/g.

It is preferable that in the entire 2-component system made of components A and B the ratio of free isocyanate groups to uretdione groups is from 1.1:1 to 1:1.1. It is moreover preferable that the ratio of free isocyanate groups to hydroxy groups is from 1.2:2 to 1:2.5.

A particularly advantageous ratio of diol to polyol has proved to be from 4:1 to 2:1.2, in particular from 6:2 to 3:2.5.

The polyol is also particularly advantageously a tetraol with OH number from 200 to 800 mg KOH/g and with molar mass from 200 to 400 g/mol or a triol with OH number from 200 to 800 mg KOH/g and with molar mass from 200 to 400 g/mol. Mixtures of these specific embodiments are also advantageous.

The present invention also relates to the following embodiments:
1. 2-Component system for the production of composites, characterized in that the first component A comprises a uretdione dimer having 2 free isocyanate groups, and comprises at least one (meth)acrylate monomer, and the second component B comprises at least one diol, at least one polyol with, on average, from 2.1 to 4 OH groups, and one optional activator for methacrylate polymerization, where
the (meth)acrylate monomer of component A has no OH group or no alkyl group substituted with an OH group; and
the diol of component B is a low-molecular-weight compound such as ethylene glycol, propylene glycol or butanediol; an oligomeric or short-chain polymeric diol such as a polyether, a polyurethane, a polyamide or a polyester having two hydroxy end groups; or a telechelic compound such as a telechelic polyolefin compound or a telechelic poly(meth)acrylate compound having two hydroxy groups.
2. 2-Component system according to embodiment 1, characterized in that the ratio by mass of component A and component B is from 4:1 to 1:1.
3. 2-Component system according to embodiment 1 or 2, characterized in that component A consists of from 10% to 50% by weight of alkyl (meth)acrylates, from 40% to 89.9% by weight of uretdione dimer, from 0% by weight to 40% by weight of polyester and/or poly(meth)acrylates and from 0.1% to 20% by weight of additives, stabilizers, catalysts, pigments and/or fillers.
4. 2-Component system according to at least one of embodiments 1 to 3, characterized in that component B consists of from 25% to 99.5% by weight of diol and polyol, from 0.5% to 5% by weight of an initiator as activator, and optionally up to 20% by weight of additives, stabilizers, catalysts, pigments and/or fillers, where the molar ratio of diol to polyol is from 6:2 to 3:2.5, the molar mass of the diol is from 50 to 300 g/mol and the molar mass of the polyol is from 90 to 800 g/mol, and the hydroxy number of the polyol is from 150 to 900 mg KOH/g.
5. 2-Component system according to at least one of embodiments 1 to 4, characterized in that in the entire 2-component system made of components A and B the ratio of free isocyanate groups to uretdione groups is from 1.1:1 to 1:1.1, and the ratio of free isocyanate groups to hydroxy groups is from 1.2:2 to 1:2.5.
6. 2-Component system according to at least one of embodiments 1 to 5, characterized in that the ratio of diol to polyol is from 4:1 to 2:1.2, and in that the polyol is a tetraol with OH number from 200 to 800 mg KOH/g and with molar mass from 200 to 400 g/mol.
7. 2-Component system according to at least one of embodiments 1 to 5, characterized in that the ratio of diol to polyol is from 6:2 to 3:2.5, and in that the polyol is a triol with OH number from 200 to 800 mg KOH/g and with molar mass from 200 to 400 g/mol.
8. 2-Component system according to at least one of embodiments 1 to 7, characterized in that the uretdione dimers used were produced from isophorone diisocyanate (IPDI), hexamethylene diisocyanate (HDI), diisocyanatodicyclohexylmethane (H12MDI), 2-methylpentane diisocyanate (MPDI), 2,2,4-trimethylhexamethylene diisocyanate/2,4,4-trimethylhexamethylene diisocyanate (TMDI) and/or norbornane diisocyanate (NBDI).
9. 2-Component system according to at least one of embodiments 1 to 8, characterized in that component A comprises from 0.01% to 5% by weight of at least one catalyst selected from quaternary ammonium salts and/or quaternary phosphonium salts having halogens, hydroxides, alkoxides or organic or inorganic acid anions as counterion, and optionally from 0.1% to 5% by weight of at least one co-catalyst selected from at least one epoxide and/or at least one metal acetylacetonate and/or quaternary ammonium acetylacetonate and/or quaternary phosphonium acetylacetonate.
10. 2-Component system according to at least one of embodiments 1 to 8, characterized in that the (meth)acrylate monomer is MMA, n-butyl (meth)acrylate, isobutyl (meth)acrylate or a mixture of these monomers, and in that the activator is a peroxide initiator.
11. Process for the production of semifinished composite products and further processing thereof to give mouldings, comprising the following steps
   I. production of a reactive composition through mixing of components A and B according to at least one of embodiments 1 to 11,
   II. direct impregnation of a fibrous carrier with the composition from I., or bringing the composition into contact with short fibres,
   III. polymerization of the (meth)acrylate monomers in the composition by means of thermal initiation, of redox initiation of a 2-component system, of electromagnetic radiation, of electron radiation or of a plasma,
   IV. shaping to give the later moulding and
   V. reaction of the uretdione groups with free OH groups at a temperature of from 120 to 200° C.,
where in step I and optionally step II at a temperature of from 10 to 100° C. a reaction takes place between the free isocyanate groups and OH groups, where step III is initiated at a temperature of up to 100° C. in parallel with steps I and/or II, or, after step II, is initiated at a temperature which is up to 180° C. but which is below the reaction temperature in step V.
12. Process according to embodiment 11, characterized in that the fibrous carriers consist for the most part of glass, carbon, plastics such as polyamide (aramid) or polyester, natural fibres, or mineral fibre materials such as basalt fibres or ceramic fibres, and in that the fibrous carriers take the form of textile sheets made of nonwoven fabric or of knitted fabric, or take the form of non-knitted structures such as woven fabrics, laid scrims or braided fabrics, or of long-fibre materials or of short-fibre materials.
13. Process according to embodiment 11 or 12, characterized in that the reaction between the uretdione groups and the hydroxy groups in step V is carried out either in the presence of a catalyst at a temperature of from 120 to 160° C. or without catalyst at a temperature of from 120 to 160° C.
14. Mouldings produced by a process according to at least one of embodiment 11 to 13.
15. Use of mouldings according to embodiment 14 in boat- and shipbuilding, in aerospace technology, in automobile construction, for two-wheeled vehicles, preferably motorcycles and pedal cycles, in the automotive, construction, medical-technology and sports sectors, the electrical and electronics industry, and in energy-generation installations, for example for rotor blades in wind turbines.

### BRIEF DESCRIPTION OF THE DRAWING

The FIGURE presents the viscosity increase measured for the matrix composition after mixing of components A and B, plotted against time (Example 1).

### DETAILED DESCRIPTION OF THE INVENTION

There are potentially three different reactions taking place independently of one another. When the two components A and B are brought together, the free isocyanate groups of the uretdione dimers react with the OH groups to give thermoplastic prepolymers that are stable in storage. The polymerization of (meth)acrylate monomers can be carried out here at the same time by means of redox initiators in the component B or subsequently by a thermal of photochemical route. After the first two reactions have taken place, the system is still thermoplastic. In the final reaction, the uretdione rings are cleaved by introduction of heat, and the resultant free isocyanate groups react with the polyols to give a network.

The advantage of this system of the invention lies in the production of a mouldable thermoplastic semifinished product/prepreg which, during the production of the composite components, is crosslinked to give a thermoset material in a further step. The starting formulation is liquid and hence suitable for impregnation of fibre material without addition of solvents. The semifinished products are stable in storage at room temperature. The resultant mouldings have higher heat distortion resistance than other polyurethane systems. They feature higher flexibility and impact resistance than familiar epoxy systems. Such matrices can moreover be designed to be lightfast, and therefore useful for production of visible carbon-based parts, sometimes without further coating.

A particular advantage of the present invention arises as follows: use of the composition of the invention permits specific and defined adjustment of the first PU reaction to give the thermoplastic. The condition known as the B-stage is thus reached. Because according to the invention there is no need to use additional inorganic substances, there is no requirement for any particular addition system, and there is no impairment of mechanical properties by the additional inorganic substances or fillers. The B-stage can then be hardened to give the final component in a stage using polymerization and PU crosslinking. Alternatively, polymerization can be carried out first, thus giving a preform which is a non-sticky product that has been preformed but not hardened. The advantage is that the preform can then react with other materials in the crosslinking stage, for example in a co-moulding procedure.

The overall outcome is therefore, in comparison with the related art, more degrees of freedom in the conduct of the process, greater mechanical stability of the final product, better optical properties of the same, and also a process that is overall simpler.

Carriers

According to the invention, the 2-component system is particularly used to produce what are known as sheet moulding compounds (SMC). These uses, as fibre material, short fibres of length by way of example 1 inch. These can by way of example be scattered and then impregnated. However, a better method designs the matrix material by way of example as film, and scatters the short fibres onto the same before or during initial curing. Materials used for such short fibres can in principle be the same as those used for the long fibres described above. However, it is also possible to make additional use of other materials, such as woodchips, that cannot be processed to give long fibres.

The fibrous carriers particularly preferably consist for the most part of glass, carbon, plastics, such as polyamide (aramid) or polyester, natural fibres, or mineral fibre materials such as basalt fibres or ceramic fibres. It is very particularly preferable to use short glass fibres or short carbon fibres.

The Uretdione Dimers

The uretdione dimers used according to the invention having free isocyanate groups are preferably uretdione dimers which were produced from isophorone diisocyanate (IPDI), hexamethylene diisocyanate (HDI), diisocyanatodicyclohexylmethane (H12MDI), 2-methylpentane diisocyanate (MPDI), 2,2,4-trimethylhexamethylene diisocyanate/2,4,4-trimethylhexamethylene diisocyanate (TMDI) and/or norbornane diisocyanate (NBDI).

Diisocyanates comprising uretdione groups are well known and are described by way of example in U.S. Pat. Nos. 4,476,054, 4,912,210, 4,929,724 and EP 417 603. A comprehensive overview of industrially relevant processes for dimerization of isocyanates to give uretdiones is found in J. Prakt. Chem. 336 (1994), 185-200. The reaction of isocyanates to give uretdiones generally takes place in the presence of soluble dimerization catalysts, for example dialkylaminopyridines, trialkylphosphines, phosphoramides or imidazoles. The reaction, optionally conducted in solvents, but preferably in the absence of solvents, is stopped—by addition of catalyst poisons—on attainment of a desired conversion. Excess monomeric isocyanate is then removed by short-path evaporation. If the catalyst is sufficiently volatile, the reaction mixture can be freed from the catalyst in the course of monomer removal. Addition of catalyst poisons may be omitted in this case. A wide range of isocyanates is suitable in principle for producing diisocyanates comprising uretdione groups.

It is preferable that the uretdione dimers used according to the invention are produced from any desired aliphatic, cycloaliphatic and/or (cyclo)aliphatic di- and/or polyisocyanates. According to the invention it is possible by way of example to use isophorone diisocyanate (IPDI), hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI) and norbornane diisocyanate (NBDI). Very particular preference is given to use of IPDI, HDI, TMDI and H₁₂MDI, and it is also possible here to use the isocyanurates.

The composition can moreover optionally comprise from 0.01% to 5% by weight, preferably from 0.3% to 2% by weight, of at least one catalyst selected from quaternary ammonium salts, preferably tetraalkylammonium salts, and/or from quaternary phosphonium salts having halogens, hydroxides, alkoxides or organic or inorganic acid anions as counterion, and from 0.1% to 5% by weight, preferably from 0.3% to 2% by weight, of at least one co-catalyst selected from at least one epoxide and/or at least one metal acetylacetonate and/or quaternary ammonium acetylacetonate and/or quaternary phosphonium acetylacetonate. All quantities stated relating to the (co-)catalysts are based on the entire formulation of the matrix material. Examples of metal acetylacetonates are zinc acetylacetonate, lithium acetylacetonate and tin acetylacetonate, alone or in mixtures. Preference is given to use of zinc acetylacetonate. Examples of quaternary ammonium acetylacetonates or quaternary phosphonium acetylacetonates can be found in DE 102010030234.1. Particular preference is given to use of tetraethylammonium acetylacetonate and tetrabutylammonium acetylacetonate. It is also, of course, possible to use mixtures of such catalysts.

Examples of the catalysts are found in DE 102010030234.1. These catalysts can be added alone or in mixtures. Preference is given to use of tetraethylammonium benzoate and tetrabutylammonium hydroxide.

Useful epoxy-containing co-catalysts include, for example, glycidyl ethers and glycidyl esters, aliphatic epoxides, bisphenol-A-based diglycidyl ethers and glycidyl methacrylates. Examples of such epoxides are triglycidyl isocyanurate (TGIC, trade name: ARALDITE 810, Huntsman), mixtures of diglycidyl terephthalate and triglycidyl trimellitate (trade name: ARALDITE PT 910 and 912, Huntsman), glycidyl esters of versatic acid (trade name: KARDURA E10, Shell), 3,4-epoxycyclohexylmethyl 3′,4′-epoxycyclohexanecarboxylate (ECC), bisphenol-A-based diglycidyl ethers (trade name: EPIKOTE 828, Shell), ethylhexyl glycidyl ether, butyl glycidyl ether, pentaerythrityl tetraglycidyl ether (trade name: POLYPOX R 16, UPPC AG), and other Polypox products having free epoxy groups. It is also possible to use mixtures. Preference is given to using ARALDITE PT 910 and 912.

Component A particularly preferably comprises at least one catalyst selected from dibutyltin dilaurate, zinc octoate, bismuth neodecanoate and/or comprises tertiary amines, preferably 1,4-diazabicyclo[2.2.2]octane, in quantities of from 0.001% to 1.0% by weight.

(Meth)acrylates

According to the invention, monomer components based on (meth)acrylate are used. The expression (meth)acrylates encompasses not only methacrylates and acrylates, and mixtures of methacrylates but also acrylates. The (meth)acrylates used have no OH group or no alkyl group substituted with an OH group.

It is preferable that the optional activator used, i.e. activator used for thermal initiation, is a peroxide initiator. If the activators, in particular photoinitiators, peroxides and/or azo initiators are added, the concentration present thereof in component B is from 0.1% to 5.0% by weight, preferably from 0.5% to 4% by weight and particularly preferably from 2% to 3% by weight.

Photoinitiators and the production thereof are by way of example described in “Radiation Curing in Polymer Science & Technology, Vol II: Photoinitiating Systems” by J. P. Fouassier and J. F. Rabek, Elsevier Applied Science, London and New York, 1993. These are frequently α-hydroxyketones or derivatives thereof, or phosphines. If the photoinitiators are present, quantities present thereof can be from 0.2% to 10% by weight. Examples of useful photoinitiators include Basf-CGI-725 (BASF), Chivacure 300 (Chitec), Irgacure PAG 121 (BASF), Irgacure PAG 103 (BASF), Chivacure 534 (Chitec), H-Nu 470 (Spectra Group limited), TPO (BASF), Irgacure 651 (BASF), Irgacure 819 (BASF), Irgacure 500 (BASF), Irgacure 127 (BASF), Irgacure 184 (BASF) and Duracure 1173 (BASF).

The monomers are in particular compounds selected from the group of the (meth)acrylates, for example alkyl (meth)acrylates of straight-chain, branched or cycloaliphatic alcohols having from 1 to 40 carbon atoms, e.g. methyl (meth)acrylate (MMA), ethyl (meth)acrylate, n-butyl (meth)acrylate or 2-ethylhexyl (meth)acrylate. The (meth)acrylate monomers are particularly preferably MMA, n-butyl (meth)acrylate, isobutyl (meth)acrylate or a mixture of these monomers. The monomer mixtures can also comprise, alongside the (meth)acrylates described above, other unsaturated monomers which are copolymerizable with the abovementioned (meth)acrylates by means of free-radical polymerization. Among these are 1-alkenes and styrenes.

Details of the composition of the monomers in terms of content and composition will advantageously be selected with a view to the desired technical function and to the carrier material to be wetted.

Component A can comprise not only the monomers listed but also polymers for which the term prepolymer is used in order to provide better distinguishability in the context of this patent, preferably polyesters or poly(meth)acrylates. These are used to improve the polymerization properties, mechanical properties, adhesion to the carrier material, viscosity adjustment during processing or wetting of the carrier material with the resin, and optical properties of the resins.

When such prepolymers are used, the proportion thereof in component A here is from 0% by weight to 40% by weight, preferably from 15% by weight to 30% by weight.

The said poly(meth)acrylates are in general composed of monomers already listed above in relation to the monomers in the resin system. They may be obtained by solution polymerization, emulsion polymerization, suspension polymerization, bulk polymerization or precipitation polymerization and are added to the system as pure substance.

The said polyesters are obtained via bulk polycondensation or ring-opening polymerization and are composed of the monomer units known for these applications.

Chain transfer agents used can be any of the compounds known from free-radical polymerization. Preference is given to use of mercaptans such as n-dodecyl mercaptan.

Diols

Diols used can by way of example be low-molecular-weight compounds such as ethylene glycol, propylene glycol or butanediol. It is moreover also possible to use oligomeric or short-chain polymeric diols. Examples here would be polyethers, polyurethanes, polyamides or polyesters having two hydroxy end groups, and also telechelic compounds, for example telechelic polyolefin compounds or telechelic poly(meth)acrylate compounds having two hydroxy groups.

Preference is given to use of low-molecular-weight diols, in particular ethylene glycol or propylene glycol.

Polyols

The polyols used according to the invention have from 2.1 to 4, preferably from 2.1 to 2.5, OH groups.

A particular advantage of the inventive addition of the polyols consists in better overall processability, the bonding between a plurality of layers of prepregs when these are pressed together, and better homogenization of the matrix material over the entire moulding.

According to the invention, the composition comprises, as OH-functional co-binders, polyols which likewise enter into a crosslinking reaction with the isocyanate components. Addition of these polyols which are reactive in steps II and IV, but not in step III, achieves greater precision in adjustment of the rheology, and therefore the processing of the semifinished products from step III, and also of the final products. The remaining free diols and polyols therefore by way of example act as plasticizers, or more precisely as reactive diluents, in the semifinished product from step III.

Suitable OH-functional co-binders are in principle any of the polyols usually used in PU chemistry, as long as their OH-functionality is within the range stated above. Functionality in the context of polyol compounds means the number of reactive OH groups present in the molecule. For the end use, it is necessary to use polyol compounds with OH functionality of at least 2.1 in order that the reaction with the isocyanate groups of the uretdiones forms a dense three-dimensional polymer network. It is also possible here, of course, to use mixtures of various polyols.

An example of a simple polyol that is suitable is glycerol. Other low-molecular-weight polyols are marketed by way of example by Perstorp® as Polyol®, Polyol® R or Capa®, by Dow Chemicals as Voranol® RA, Voranol® RN, Voranol® RH or Voranol® CP, by BASF as Lupranol® and by DuPont as Terathane®. Specific products, with hydroxy numbers and molar masses can be found by way of example in the German patent application having the priority reference 102014208415.6.

Other Constituents of the 2-Component Systems and of the Prepregs or Composites Produced Therefrom

The 2-component systems of the invention can also comprise other additional substances in addition to the (meth)acrylates, the uretdione dimers, the polyols, the diols and the activator. The said substances can in particular be additives, stabilizers, in particular UV stabilizers, catalysts, pigments and/or fillers.

Auxiliaries and additives additionally used may be chain transfer agents, plasticizers and/or inhibitors. It is moreover possible to add dyes, wetting agents, dispersing and levelling agents, e.g. polysilicones, adhesion promoters, for example those based on acrylate, antifoams and rheology additives.

It is therefore possible by way of example to add light stabilizers, e.g. sterically hindered amines, or other auxiliaries as described by way of example in EP 669 353, in a total quantity from 0.05% to 5% by weight. Fillers and pigments, for example titanium dioxide, can be added in a quantity of up to 20% by weight, based on component A.

It is equally possible to use conventional UV stabilizers. The UV stabilizers are preferably selected from the group of the benzophenone derivatives, benzotriazole derivatives, thioxanthonate derivatives, piperidinolcarboxylic ester derivatives or cinnamic ester derivatives. Among the group of stabilizers and inhibitors, preference is given to use of substituted phenols, hydroquinone derivatives, phosphines and phosphites.

Rheology additives used are preferably polyhydroxycarboxamides, urea derivatives, salts of unsaturated carboxylic esters, alkylammonium salts of acidic phosphoric acid derivatives, ketoximes, amine salts of p-toluenesulfonic acid, amine salts of sulfonic acid derivatives and aqueous or organic solutions or mixtures of the compounds. It has been found that rheology additives based on fumed or precipitated, optionally also silanized, silicas having BET surface area from 10 to 700 nm²/g are particularly suitable.

Antifoams are preferably selected from the group of alcohols, hydrocarbons, paraffin-based mineral oils, glycol derivatives, derivatives of glycolic esters, acetic esters and polysiloxanes.

The Process of the Invention

The objects additional to the two-component system of the invention are also achieved via a novel process for the production of composite semifinished products or prepregs and further processing thereafter to give mouldings, where the 2-component system of the invention is used. This novel process has the following steps:

I. production of a reactive composition through mixing of components A and B, as described above,

II. direct impregnation of a fibrous carrier with the composition from I., or bringing the composition into contact with short fibres,

III. polymerization of the (meth)acrylate monomers in the composition by means of thermal initiation, of redox initiation of a 2-component system, of electromagnetic radiation, of electron radiation or of a plasma,

IV. shaping to give the later moulding and

V. reaction of the uretdione groups with free OH groups at a temperature of from 120 to 200° C.

According to the invention, a reaction takes place here between the free isocyanate groups and the OH groups in step I and optionally step II at a temperature of from 10 to 100° C.

In particular, preference is given to an embodiment in which the reaction between the free isocyanates and the hydroxy groups in step I and/or II takes place at room temperature, and step III then takes place at a temperature of from 60 to 150° C.

In step III, according to the invention, the polymerization is initiated at a temperature of up to 100° C. in parallel with steps I and/or II, or, after Step II, is initiated at a temperature which is up to 180° C., but which is below the reaction temperature in step V.

It is preferable that the reaction between the uretdione groups and the hydroxy groups in step V is carried out either in the presence of a catalyst at a temperature of from 120 to 160° C. or without catalyst at a temperature of from 120 to 160° C.

Step II, impregnation, is effected by saturating the fibres, woven fabrics or laid scrims with the formulation produced in step I. The impregnation preferably takes place at room temperature.

Step III, hardening of the resin component, preferably takes place directly after step II. The hardening is achieved by way of example by irradiation with electromagnetic radiation, preferably UV radiation, by electron beams, or by application of a plasma field. Alternatively, thermal initiation or redox initiation can also take place, with respective presence of appropriate activators, or in this case initiators/initiator systems. Care must be taken here to ensure that the temperature is below the hardening temperature required for step V.

In step IV, the resultant composite semifinished products/prepregs can, as required, be combined to give various shapes and cut to size. In particular, in order to consolidate a plurality of composite semifinished products to give a single composite, and prior to a final crosslinking of the matrix material to give the matrix, the semifinished products are cut to size, and optionally sewn or fixed by other means.

In step V, the final hardening of the composite semifinished products takes place to give the mouldings which are crosslinked to give a thermoset material. This is achieved via thermal hardening of the hydroxy groups of component B with the uretdione groups from component A. For the purposes of this invention, this procedure of production of the composite components from the prepregs at temperatures above 160° C., as required by hardening time, uses reactive matrix materials (variant I), or uses highly reactive matrix materials (variant II) with appropriate catalysts at temperatures above 120° C. In particular, the hardening is carried out at a temperature of from 120 to 200° C. particularly preferably at a temperature of from 120 to 180° C., in particular from 130 to 140° C. The hardening time in step V is usually within from 5 to 60 minutes.

During the hardening in step V, the composite semifinished products can additionally be pressed in a suitable mould with use of pressure and optionally application of vacuum.

After step III and, respectively IV, the composite semifinished products/prepregs produced according to the invention exhibit very high stability in storage at room temperature. The said stability depends on the reactive polyurethane composition of the present, and continues for at least some days at room temperature. The composite semifinished products are generally stable in storage for a number of weeks at 40° C. and below, and also for a number of years at room temperature. The resultant prepregs are not sticky, and therefore have very good handling and further-processing properties. Accordingly, the reactive or highly reactive polyurethane compositions used according to the invention exhibit very good adhesion and distribution on the fibrous carrier.

In particular, the 2-component system of the invention has the following advantages over the systems described in the application EP 2 661 459:
The low viscosity of the composition before step III can also be ensured with comparatively low (meth)acrylate concentrations. The relatively low (meth)acrylate content gives a more ductile final product.
Prepolymers can be produced directly on the fibre by in-situ polymerization. A reaction step is therefore omitted, and production costs can thus be reduced.
The nature of the polymerization procedure under the initiator selected can be varied to give a sticky or dry semifinished product from step IV. In contrast to this, EP 2 661 459 can provide only dry semifinished products. Sticky semifinished products have better suitability for manual processing methods.

The reactive 2-component systems that can be used according to the invention, and the downstream products produced therefrom, are moreover environmentally friendly and inexpensive, have good mechanical properties, and are easy to process, and after curing feature good weathering resistance, and also a balanced ratio of hardness to flexibility.

It was moreover possible to achieve a significant reduction of the pressure in the pressed mould in comparison with previous processes; this permits the use of substantially less expensive tooling and/or of a simpler press.

Another achievement, relating to mechanical properties, was improved interlaminar shear strength.

A prepreg of the invention moreover exhibits a lower glass transition temperature of the matrix material. Better flexibility of the dry semifinished product is thus achieved; this in turn facilitates further processing. Surprisingly, however, in comparison with the related art of a system without polyols, it was possible to maintain the thermal stability of the crosslinked component.

Hardening in Step III

As stated, there are various technical options for hardening the reactive resin without involvement of the polyols and the isocyanate component in step III.

In a first alternative, the hardening is achieved thermally. To this end, peroxides and/or azo initiators, as activators, are admixed with the reactive resin, and, when the temperature is increased to a decomposition temperature appropriate for the respective initiator, initiate the hardening in the resin component. These initiators and the attendant decomposition temperatures are well known to the person skilled in the art. Suitable initiation temperatures for the said thermal hardening in the process described are preferably above ambient temperature by at least 20° C. and below the hardening temperature in step V by at least 10° C. Suitable initiation can therefore by way of example take place at from 40 to 70° C. The initiation temperature selected for the thermal initiation procedure is generally from 50 to 110° C.

The procedure known as redox initiation provides an alternative to thermal initiation. This involves producing a 2-component redox system consisting, in the first component, of an initiator, generally a peroxide, preferably dilauroyl peroxide and/or dibenzoyl peroxide, in a second component, of an accelerator, generally an amine, preferably a tertiary aromatic amine, by mixing the two components. The mixing, which generally takes place as final sub-step in step I, brings about initiation, which then permits impregnation in step II, within an open window, generally from 10 to 40 min. Accordingly, with this type of initiation, which can be carried out at room temperature, step II must be carried out within the said open window, after step I.

The third alternative is photoinitiation, for example by means of electromagnetic radiation (especially UV radiation), electron beams or a plasma. UV curing and UV lamps are by way of example described in “Radiation Curing in Polymer Science & Technology, Vol I: Fundamentals and Methods” by J. P. Fouassier, J. F. Rabek, Elsevier Applied Science, London and New York, 1993, Chapter 8, pages 453 to 503. Preference is given to use of UV lamps which emit little, if any, thermal radiation for example UV LED lamps.

Electron-beam curing and electron-beam hardeners are for example described in “Radiation Curing in Polymer Science & Technology, Vol I: Fundamentals and Methods” by J. P. Fouassier, J. F. Rabek, Elsevier Applied Science, London and New York, 1993, Chapter 4, pages 193 to 225 and in Chapter 9, pages 503 to 555. If electron beams are used to initiate polymerization, there is then no requirement for photoinitiators.

The same applies to plasma applications. Plasmas are frequently used in vacuo. Plasma polymerization of MMA is described by way of example in C. W. Paul, A. T. Bell and D. S. Soong “Initiation of Methyl Methacrylate Polymerization by the Nonvolatile Products of a Methyl Methacrylate Plasma. 1. Polymerization Kinetics” (Macromolecules 1985, Vol. 18, 11, 2312-2321). A vacuum plasma as above is used here.

According to the invention, the free-radical source used in the present process is known as an atmospheric-pressure plasma. To this end it is possible by way of example to use commercially available plasma jets/plasma beams of the type supplied by way of example by Plasmatreat GmbH or by Diener GmbH. The plasma operates under atmospheric pressure, and is used inter alia in the automobile industry for removal of grease or other contaminants on surfaces. According to the invention, unlike in the plasma process described in the literature, the plasma is generated outside of the actual reaction zone (polymerization), and blown at high velocity onto the surface of the composites to be treated. This produces as it were a “plasma flare”. The process has the advantage that the substrate does not influence the actual formation of the plasma; this leads to high process reliability. The plasma jets are normally operated with air, the result therefore being an oxygen/nitrogen plasma. The plasma is generated by electrical discharge within the nozzle of the plasma jets. The electrodes are electrically isolated. The voltage applied is sufficiently high to cause sparking between electrodes. This results in discharge. The number of discharges per unit of time can be varied here. The discharges can result from pulsing of a DC voltage. Another possible method uses AC voltage to achieve the discharges.

After production of the prepreg on the fibre with the aid of radiation or plasmas in step III of the process of the invention, this product can be stacked and converted to the desired form.

The polymer compositions used according to the invention provide very good flow properties at low viscosity, and therefore good impregnation capability, and in the hardened condition provide excellent chemicals resistance.

The composite semifinished products produced according to the invention from step III or IV moreover are very stable in storage at room temperature, generally for a number of weeks and even months. They can therefore be further processed at any time to give composite components. This is the essential difference from prior-art systems which are reactive and not stable in storage, because the latter begin to react, and therefore to crosslink, for example to give polyurethanes, immediately after application.

Thereafter, the storable composite semifinished products can then be further processed at a subsequent juncture to give composite components. Use of the composite semifinished products of the invention achieves very good impregnation of the fibrous carrier, because the liquid resin components comprising the isocyanate component are very effective in wetting the fibre of the carrier; prior homogenization here avoids exposure of the polymer composition to the thermal stress that can lead to onset of a second crosslinking reaction; the steps of grinding and sieving to give individual particle size fractions are moreover omitted, and higher yield of impregnated fibrous carrier can therefore be achieved.

Another major advantage of the composite semifinished products produced according to the invention is that in this process of the invention there is no essential requirement for high temperatures of the type required at least for a short time in the melt-impregnation process or during sintering to apply pulverulent reactive polyurethane compositions.

The invention also provides the use of the prepregs, in particular with fibrous carriers made of glass fibres, of carbon fibres or aramid fibres, or in the form of an SMC. The invention in particular also provides the use of the prepregs produced according to the invention for the production of composites in boat- and shipbuilding, in aerospace technology, in automobile construction, for two-wheeled vehicles, preferably motorcycles and pedal cycles, in the automotive, construction, medical-technology and sports sectors, the electrical and electronics industry, and in energy-generation installations, for example for rotor blades in wind turbines.

The invention also provides the mouldings or composite components produced from the composite semi-finished products or prepregs produced according to the invention, composed of at least one fibrous carrier and of a matrix formed from final hardening of the 2-component system.

### Examples

The procedure began with provision of components A and B. To this end, the starting materials were homogenized with the aid of a high-speed stirrer for 1 h at RT. The tables below provide some detail of the compositions of the two components. The viscosity of component A equalled 2.5 Pas, and that of component B was 1 Pas, measured by the cone-on-plate method. Table 1 shows the composition of component A. Table 2 shows the composition of component B.

TABLE 1
Component A

| | | Input | | Based on |
|---|---|---|---|---|
| | Supplier | weights | | component A |
| Isophorone diisocya- | Evonik | 48.2 | g | 61.4% |
| nate dimer 17.5% | | | | by wt. |
| NCO_{free} + 19.9% NCOₗₐₜₑₙₜ | | | | |
| IBOA | Evonik | 19.8 | g | 25.2% |
| IBOMA | Evonik | 9.9 | g | 12.6% |
| DBN | Sigma Aldrich | 0.5 | g | 0.64 |
| 4-Hydroxy-TEMPO | Sigma Aldrich | 0.05 | g | 0.064% |

| | |
|---|---|
| Total | 100% |

TABLE 2
Component B

| | | Input | | Based on |
|---|---|---|---|---|
| | Supplier | weights | | component B |
| Ethylene glycol | Sigma Aldrich | 0.1 mol; 6.2 g | | 28.7% |
| Lupranol 3504 | BASF | 0.076 mol; 14.9 g | | 68.9% |
| Cumene | United Initiators | 0.5 | g | 2.31% |
| hydroperoxide | | | | |
| DBTL | Sigma Aldrich | 0.027 | g | 0.125% |

| | |
|---|---|
| Total | 100% |

The resultant low-viscosity components were then applied in a mixing ratio of 2:1 (A:B) on a fibre-reinforced Teflon film through a 2-component applicator gun with a static mixer, and then short fibres were distributed manually on the coated films. The system was compressed in order to transfer the mixture from the film to the fibres. At the same time, the reaction between the free isocyanate groups and the OH groups began, with a viscosity increase (see the FIGURE) at RT.

The NCO_{free} value was determined by way of (back-)titration of the reaction of an amine ((di)butylamine) with the isocyanate groups, using hydrochloric acid (HCl). Bromophenol blue was used as indicator. After 6 hours at RT, there were no free NCO groups detectable by this method, i.e. prepolymer formation had concluded. GPC analysis with styrene calibration showed that distribution of the prepolymers was monomodal (Mw 6000 g/mol and Mn 2700 g/mol). The resultant intermediate product was sticky, and stable for 10 days at RT. The polymerization reaction between (meth)acrylates and the crosslinking reaction to give the polyurethanes could be realized within 3 min at 180° C. The T_{g} of the final product was 125° C. determined by means of DSC.

### EXPLANATION OF THE FIGURE

The FIGURE presents the viscosity increase measured for the matrix composition after mixing of components A and B, plotted against time (Example 1).

1. A 2-component system for the production of composites, comprising:
a component A, and
a component B,
wherein
component A comprises a uretdione dimer having 2 free isocyanate groups, and comprises at least one (meth)acrylate monomer, and
component B comprises at least one diol, at least one polyol with, on average, from 2.1 to 4 OH groups, and one optional activator for methacrylate polymerization, wherein the (meth)acrylate monomer of component A has no OH group or no alkyl group substituted with an OH group; and
the diol of component B is a low-molecular-weight compound; an oligomeric or short-chain polymeric diol; or a telechelic compound.

2. The 2-component system according to claim 1, wherein a ratio by mass of component A and component B is from 4:1 to 1:1.

3. The 2-component system according to claim 1, wherein component A comprises from 10% to 50% by weight of alkyl (meth)acrylates, from 40% to 89.9% by weight of uretdione dimer, from 0% by weight to 40% by weight of polyester and/or poly(meth)acrylates and from 0.1% to 20% by weight of an additive, a stabilizer, a catalyst, a pigment and/or a filler.

4. The 2-component system according to claim 1, wherein the component B comprises from 25% to 99.5% by weight of diol and polyol, from 0.5% to 5% by weight of an initiator as activator, and optionally up to 20% by weight of an additive, a stabilizer, a catalyst, a pigment and/or a filler, wherein a molar ratio of diol to polyol is from 6:2 to 3:2.5, the molar mass of the diol is from 50 to 300 g/mol and the molar mass of the polyol is from 90 to 800 g/mol, and the hydroxy number of the polyol is from 150 to 900 mg KOH/g.

5. The 2-component system according to claim 1, wherein the entire 2-component system consists of component A and component B, a ratio of free isocyanate groups to uretdione dimer is from 1.1:1 to 1:1.1, and a ratio of free isocyanate groups to hydroxy groups is from 1.2:2 to 1:2.5.

6. The 2-component system according to claim 1, wherein the ratio of diol to polyol is from 4:1 to 2:1.2, and the polyol is a tetraol with an OH number from 200 to 800 mg KOH/g and with a molar mass from 200 to 400 g/mol.

7. The 2-component system according to claim 1, wherein the ratio of diol to polyol is from 6:2 to 3:2.5, and the polyol is a triol with an OH number from 200 to 800 mg KOH/g and with a molar mass from 200 to 400 g/mol.

8. The 2-component system according to claim 1, wherein the uretdione dimer used is produced from isophorone diisocyanate (IPDI), hexamethylene diisocyanate (HDI), diisocyanatodicyclohexylmethane (H12MDI), 2-methylpentane diisocyanate (MPDI), 2,2,4-trimethylhexamethylene diisocyanate/2,4,4-trimethylhexamethylene diisocyanate (TMDI) and/or norbornane diisocyanate (NBDI).

9. The 2-component system according to claim 1, wherein component A comprises from 0.01% to 5% by weight of at least one catalyst selected from quaternary ammonium salts and/or quaternary phosphonium salts having halogens, hydroxides, alkoxides or organic or inorganic acid anions as counterion, and optionally from 0.1% to 5% by weight of at least one co-catalyst selected from at least one epoxide and/or at least one metal acetylacetonate and/or quaternary ammonium acetylacetonate and/or quaternary phosphonium acetylacetonate.

10. The 2-component system according to claim 1, wherein the (meth)acrylate monomer is MMA, n-butyl (meth)acrylate, isobutyl (meth)acrylate or a mixture of these monomers, and the activator is a peroxide initiator.

11. A process for the production of a semifinished composite product and further processing thereof to give a moulding, the process comprising:
I. producing a reactive composition through mixing of components A and B according to claim 1,
II. directly impregnating a fibrous carrier with the composition from I, or bringing the composition into contact with short fibres,
III. polymerizing the (meth)acrylate monomers in the composition by thermal initiation, redox initiation of a 2-component system, electromagnetic radiation, electron radiation or a plasma,
IV. shaping to give the moulding, and
V. reacting uretdione groups with free OH groups at a temperature of from 120 to 200° C.,
wherein, in step I, and optionally step II, at a temperature of from 10 to 100° C. a reaction takes place between the free isocyanate groups and OH groups, wherein step III is initiated at a temperature of up to 100° C. in parallel with steps I and/or II, or, after step II, is initiated at a temperature which is up to 180° C. but which is below the reaction temperature in step V.

12. The process according to claim 11, wherein the fibrous carrier comprises for the most part of glass, carbon, plastics, natural fibres, or mineral fibre materials, and the fibrous carrier takes the form of a textile sheet made of nonwoven fabric or of knitted fabric, or takes the form of a non-knitted structures, or of long-fibre material or of short-fibre material.

13. The process according to claim 11, wherein the reaction between the uretdione groups and the hydroxy groups in step V is carried out either in the presence of a catalyst at a temperature of from 120 to 160° C. or without catalyst at a temperature of from 120 to 160° C.

14. A moulding produced by the process according to claim 11.

15. The moulding according to claim 14, wherein the moulding is suitable for boatbuilding and shipbuilding, for aerospace technology, for automobile construction, for two-wheeled vehicles, for the automotive, construction, medical-technology and sports sectors, the electrical and electronics industry, and for energy-generation installations.
